(19) United States
(12) Patent Application Publication
(10) Pub. No.: US 2024/0303395 A1
(43) Pub. Date: Sep. 12, 2024

(54) APPARATUS AND METHOD FOR SIMULATING A THREE-DIMENSIONAL OBJECT

(71) Applicant: TIRA TECHNOLOGIES PRIVATE LIMITED, Singapore (SG)

(72) Inventor: Li Hong Andrea QUEK, Singapore (SG)

(21) Appl. No.: 18/668,109

(22) Filed: May 17, 2024

Related U.S. Application Data
(63) Continuation-in-part of application No. 17/529,299, filed on Nov. 18, 2021.

(51) Int. Cl. G06F 30/20; G06F 113/12

(52) U.S. Cl. CPC G06F 30/20; G06F 2113/12

(57) ABSTRACT

A computer-implemented method and apparatus for generating a soft body file for storing information for simulating a three-dimensional object to be projected on the two-dimensional plane, the three-dimensional object having an at least one soft body surface and a grid-based topology, the soft body file comprising an at least one array of vertices of the at least one soft body surface, a grid dimension of grid-based topology, and an grid points occupancy array of the grid-based topology for the array of vertices of the at least one soft body surface.

### CROSS-REFERENCE TO RELATED APPLICATIONS

The present application claims the benefit of the U.S. patent application Ser. No. 17/529,299 filed on 18 Nov. 2021, the entire disclosure of which is incorporated herein by reference and made a part of this application.

### TECHNICAL FIELD

Embodiments of the present disclosure relate to data processing and storage techniques used for simulation of three-dimensional objects. Further embodiments relate to the efficient generation and storage of a three-dimensional object to be used for simulation.

### BACKGROUND

With the advent of faster computer processing and advancements made to graphic processing units, the field of computer aided design (CAD) programs has been used to simulate a wide range of three-dimensional objects, allowing a user to visualise three-dimensional objects on a two-dimensional plane, e.g., a computer screen.

One of the significant challenges in this field is how to achieve smooth and seamless cloth simulation while maintaining a low file size to conserve both on storage and other computing resources and allow delivery of simulation files via low-speed networks.

While existing CAD programs have been used to simulate textile, these CAD programs do not realistically represent a textile from which the cloth article is intended to be produced.

For example, existing CAD programs focus on modifying the flat shape and carrying modifications of the flat shape into a mesh of polygons built based on the shape of the article in three-dimensions. Particle-based cloth simulation models, as is the state of the art, are highly sensitive to the number and arrangement of points and present a significant strain on resources especially when seeking to achieve a realistic or accurate representation of a continuous surface.

The cloth simulation should accurately reflect the properties of the textile, the changing of conditions, types of fabrics, layering and so forth. Existing CAD programs base the cloth simulation topology directly on the three-dimensional mesh topology, when in many cases the three-dimensional mesh cannot and does not reflect the properties (e.g., stretch in various directions) of the textile.

Therefore, it is often the case that the physical production of an article drawn up in existing CAD programs does not accurately match its digital counterpart in form and behaviour and simulation of the same lacks realism since those require a significant amount of data to achieve a meaningful result that cannot be met by the available storage devices, communication speed available or processing power.

Accordingly, there is a need for a technical solution for an efficient and accurate generation and storage of a three-dimensional object to be used for simulation or for the physical production of an article drawn up in a CAD program.

### SUMMARY

The present disclosure provides for an efficient generation and storage of a three-dimensional object to be used for simulation or the physical production of an article drawn up in a CAD program. The present disclosure apparatus and method achieves a significant data storage saving allowing for more accurate and faster simulations of three-dimensional objects representing fabrics or cloth within a computerized system. The present disclosure apparatus and method achieves an accurate three-dimensional object representing fabrics or cloth representation on smaller data storage spaces allowing for the accurate and fast physical reproduction of the three-dimensional object using a fabric.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes an apparatus, having a computer processor, a volatile memory, a non-volatile memory, the computer processor connected to the volatile memory and the non-volatile memory, the computer processor executing computer-executable instructions for generating a soft body file for storing information for simulating a three-dimensional object to be projected on a two-dimensional plane, the three-dimensional object having an at least one soft body surface and a grid-based topology, the soft body file a header portion, a body portion and an end portion, the body portion may include an at least one array of vertices of the at least one soft body surface. The apparatus also includes a grid dimension of the grid-based topology. The apparatus also includes and an array of grid point occupancy of the grid-based topology for the at least one array of vertices of the at least one soft body surface. Other embodiments of this aspect include corresponding computer systems, apparatus, and computer programs recorded on one or more computer storage devices, each configured to perform the actions of the methods.

Implementations may include one or more of the following features. The apparatus where the grid dimension of the grid-based topology may include at least two parameters selected from the group of parameters consisting of: a total number of grid points, a total number of rows, and a total number of columns. The array of grid point occupancy may include an array of numbers alternating between a number of consecutive grid points that are occupied and a number of consecutive grid points that are unoccupied when all grid points are scanned column by column or row by row. The three-dimensional object is a pixel array to be projected on a screen. The soft body file further may include a global simulation data. The soft body file further may include spring types, each spring type may include a vector on the grid-based topology and a spring definition. The spring definition may include a distance constraint between two vertices of the at least one array of vertices of the at least one soft body surface. The soft body file further may include a UV mapping origin based on the grid-based topology, a UV mapping resolution of a scale of each cell based on the grid-based topology and at least one UV offset may include an element in the array of vertices and an element UV coordinate. The element is an identification of a vertex. The element UV coordinate is a two-dimensional vector. The element UV coordinate is a position where the element is added to the two-dimensional point of a corresponding grid point in two-dimensional space. The soft body file further may include at least one attachment pair, the at least one attachment pair defining two vertices of the at least one array of vertices that are not adjacent to each other on the two-dimensional plane but are attached to each other on the three-dimensional object. The soft body file further may include an at least one relationship between an at least one dependent object and the at least one soft body surface. The at least one relationship between the at least one dependent object and the at least one soft body surface may include a position on the at least one soft body surface based on three or more vertices of the array of vertices. The soft body file further may include a material specification data representing physical properties of a soft body material to be stored. The soft body file further may include a flat pattern data, the flat pattern data may include: an at least one boundary curve having two subsets, where the at least one boundary curve may include an array of elements of the at least one array of vertices of the least one soft body surface; and an at least one boundary segment pair of the two subsets of the at least one boundary curve, where the two subsets of the at least one boundary curve are to be attached in three-dimensional space. Implementations of the described techniques may include hardware, a method or process, or computer software on a computer-accessible medium.

One general aspect includes a computer-implemented method for simulating a three-dimensional object to be projected on a two-dimensional plane within a computer, the computer having a computer processor, a volatile memory, a non-volatile memory, the computer processor connected to the volatile memory and the non-volatile memory, the computer processor executing computer-executable instructions for generating a soft body file for storing information for simulating the three-dimensional object to be projected on the two-dimensional plane, the three-dimensional object having an at least one soft body surface and a grid-based topology, generating a soft body file, the soft body file may include an at least one array of vertices of the at least one soft body surface. The computer-implemented method also includes a grid dimension of the grid-based topology. The method also includes and an grid points occupancy array of the grid-based topology for the array of vertices of the at least one soft body surface. Other embodiments of this aspect include corresponding computer systems, apparatus, and computer programs recorded on one or more computer storage devices, each configured to perform the actions of the methods.

Implementations may include one or more of the following features. The method where the soft body file further may include a global simulation data 208. The soft body file further may include at least one attachment pair identifying two vertices of the at least one array of vertices of the at least one soft body surface that are not adjacent to each other on a two-dimensional plane but are attached to each other on the three-dimensional object. The soft body file further may include at least one relationship between an at least one dependent object and the at least one soft body surface. The relationship between the at least one dependent object and the at least one soft body surface may include a position on the at least one soft body surface based on three or more vertices of the at least one array of vertices of the at least one soft body surface. The soft body file further may include a material specification data representing physical properties of a soft body material to be stored. The soft body file further may include a flat pattern data, the flat pattern data may include at least one boundary segment pair of two subsets of at least one boundary curve, where the at least one boundary curve may include an array of indices of vertices of the at least one array of vertices of the at least one soft body surface, and where the two subsets of the at least one boundary curve to be attached in three-dimensional space. The grid dimension of the grid-based topology may include two parameters selected from the group consisting of: a total number of grid points, a total number of rows, and a total number of columns. The array of grid point occupancy may include an array of numbers alternating between a number of consecutive grid points that are occupied and a number of consecutive grid points that are unoccupied when all the grid points are scanned column by column or row by row. The soft body file further may include spring types defining a vector on the grid-based topology and a spring definition. The spring definition may include a distance constraint between two vertices of the at least one array of vertices of the at least one soft body surface. The soft body file further may include a UV mapping origin based on the grid-based topology, a UV mapping resolution of a scale of each cell based on the grid-based topology and at least one UV offset may include an element in the array of vertices, and an element UV coordinate. The element is an identification of a vertex. The element UV coordinate is a two-dimensional vector. The element UV coordinate is a position when the clement is added to a two-dimensional position of the vertex's corresponding grid point in two-dimensional space. Implementations of the described techniques may include hardware, a method or process, or computer software on a computer-accessible medium.

One general aspect includes a computer-readable medium having computer-executable instructions for generating a soft body file for storing information for simulating a three-dimensional object, the three-dimensional object having an at least one soft body surface and a grid-based topology, the computer-executable instructions may include generating a soft body file may include an at least one array of vertices of the at least one soft body surface. The computer-readable medium also includes a grid dimension of the grid-based topology. The medium also includes and an array of grid point occupancy of the grid-based topology for the at least one array of vertices of the at least one soft body surface. Other embodiments of this aspect include corresponding computer systems, apparatus, and computer programs recorded on one or more computer storage devices, each configured to perform the actions of the methods.

### BRIEF DESCRIPTION OF THE DRAWINGS

For the present disclosure to be better understood and for its practical applications to be appreciated, the following Figures are provided and referenced hereafter. It should be noted that the Figures are given as examples only and in no way limit the scope of the invention.

FIG. 1 is a schematic high-level illustration of a computer system and environment for the generation, storage and use of a soft body file, in accordance with some embodiments of the present disclosure.

FIG. 2 is a schematic illustration of an example of a structure of a soft body file storing data for simulating a three-dimensional object, in accordance with some embodiments of the present disclosure.

FIG. 3 is a schematic illustration of a process of generating a body portion of the soft body file, according to some embodiments of the present disclosure.

FIG. 4 is a schematic illustration of an example of an array of grid point occupancy with some occupied grid points, in accordance with some embodiments of the present disclosure.

FIG. 5 is a graphical representation showing file sizes of a three-dimensional modelling files for certain file formats, in accordance with some embodiments of the present disclosure.

FIG. 6 is a graphical representation showing file sizes of three-dimensional modelling files without texture for certain file formats, in accordance with some embodiments of the present disclosure.

FIG. 7 is a graphical representation showing file sizes of three-dimensional modelling file with mesh only for certain file formats, in accordance with some embodiments of the present disclosure.

FIG. 8 is a graphical representation showing file sizes of three-dimensional modelling file with mesh only for certain file formats, in accordance with some embodiments of the present disclosure.

Identical or duplicate or equivalent or similar structures, elements, or parts that appear in one or more drawings are generally labelled with the same reference numeral, optionally with an additional letter or letters to distinguish between similar entities or variants of entities and may not be repeatedly labelled and/or described. References to previously presented elements are implied without necessarily further citing the drawing or description in which they appear.

### DETAILED DESCRIPTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

Although embodiments of the invention are not limited in this regard, the terms

“plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

For abbreviation purposes, the terms 3D, three-dimensional, or three dimensions may also be referred to as 3D; the terms 2D, two-dimensional, or two dimensions may be referred to as 2D; the term 3D surface includes and may also refer to 3D surfaces.

As used herein, the term “soft body” includes any soft or pliable material, including but not limited to cloth, fabric, and textiles.

As used herein, the term “piece” refers to data or information relating to a component that, when assembled, makes up the three-dimensional object simulated. For example, where the three-dimensional object simulated is clothing, a “piece” refers to data or information relating to an individual piece of cloth that makes up the clothing when assembled.

As used herein, the term “UV mapping” refers to a process of projecting a 2D image or texture onto a simulated 3D object's surface for texture mapping. The term “UV” refers to the dimensional (2D) nature of the process of UV mapping, the letters “U” and “V” denoting the horizontal axis and vertical axis of the 2D texture, respectively. The term “UV mapping” refers to the grid or guide used for patterning the surface of the simulated 3D object.

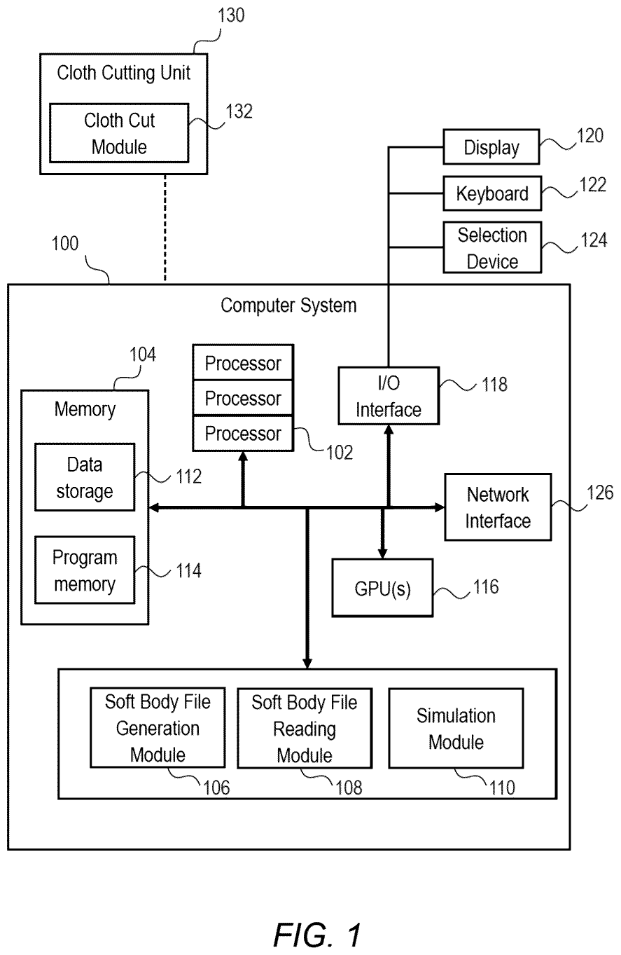

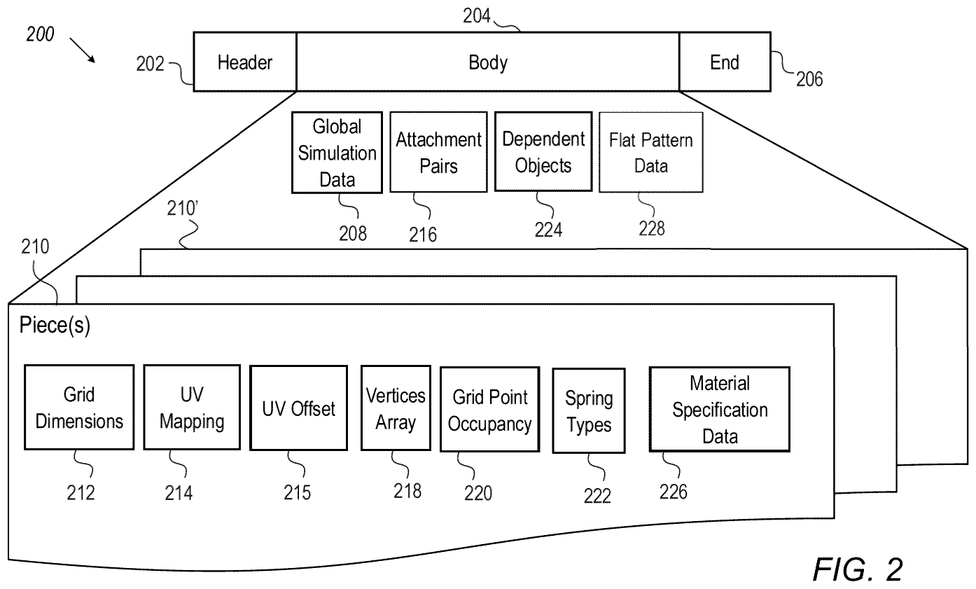

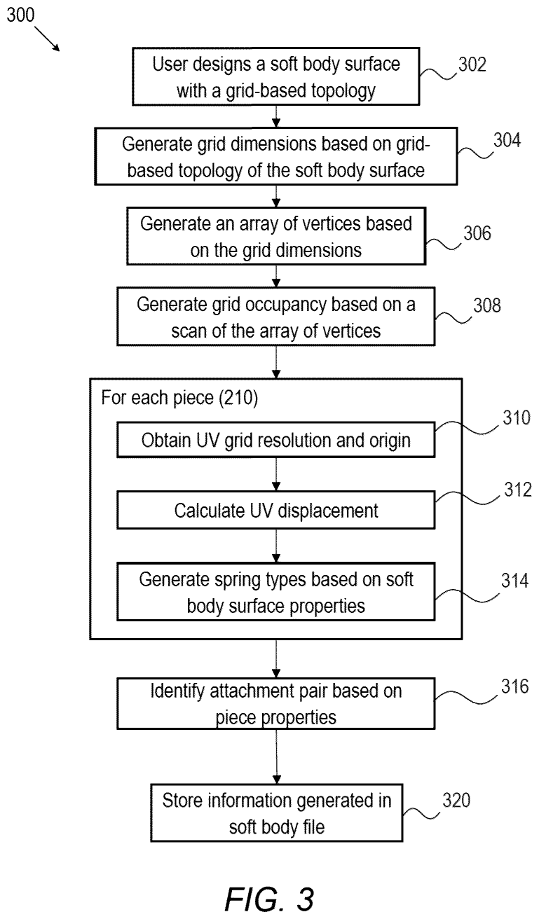

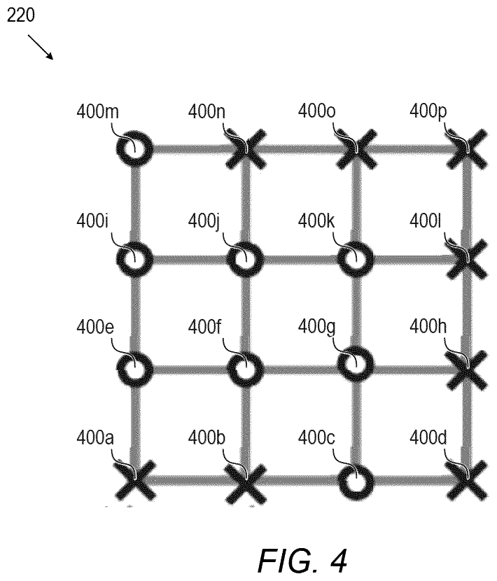

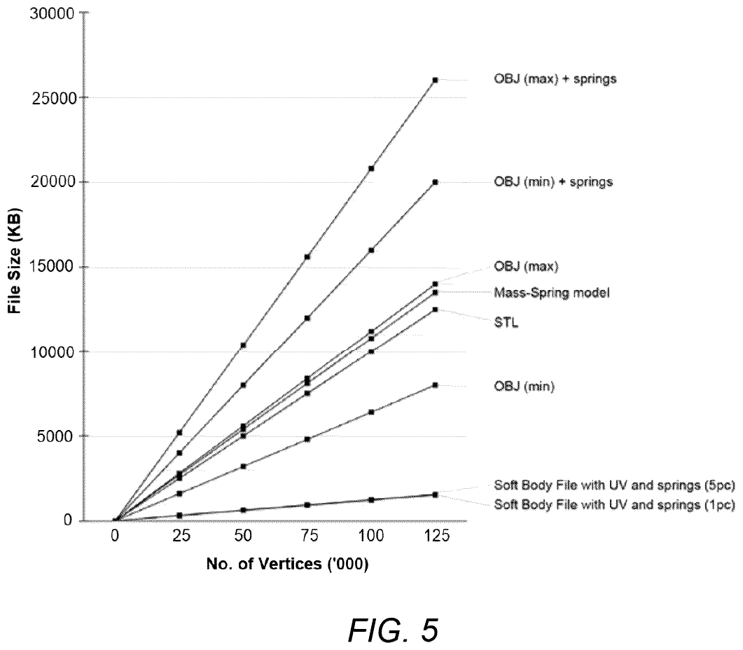

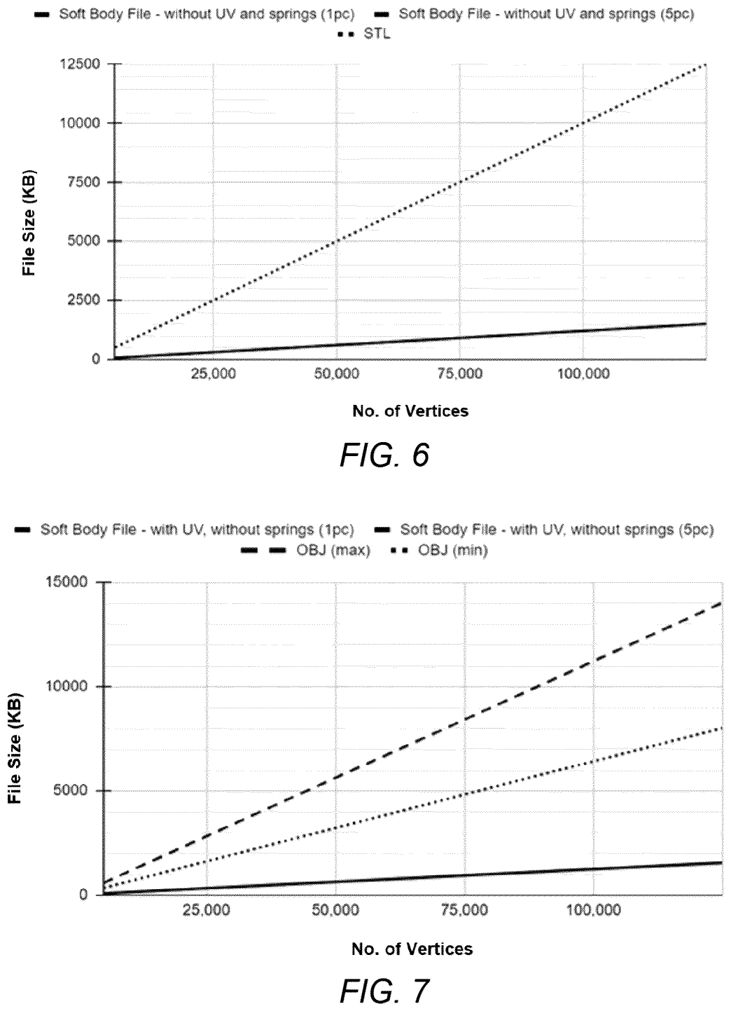

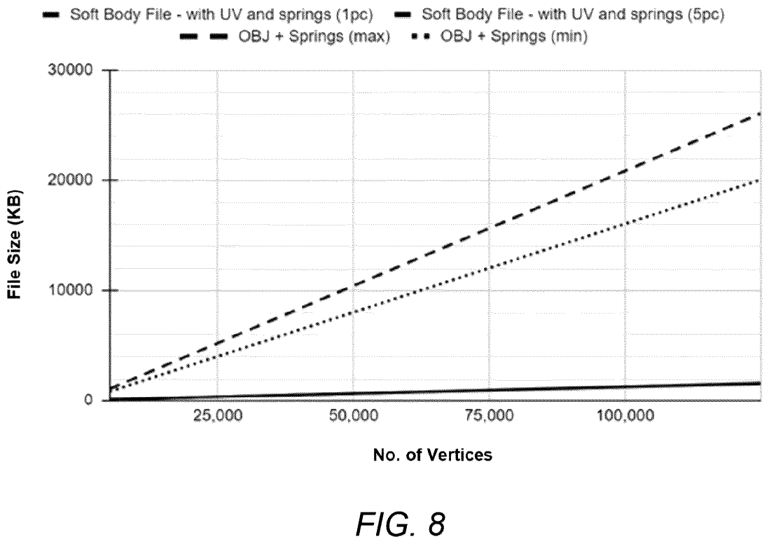

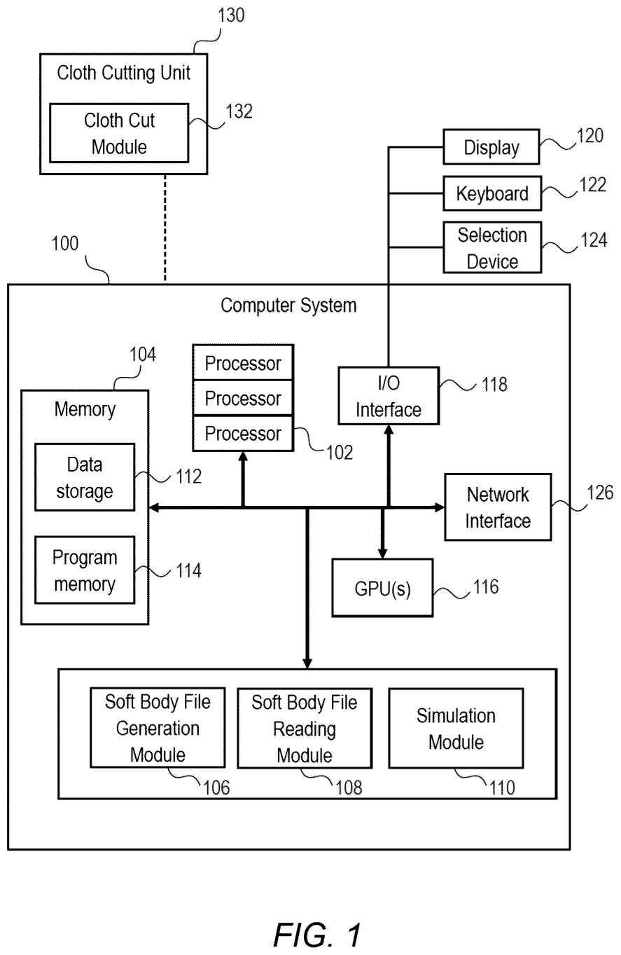

FIG. 1 is a high-level diagram schematic of a computer system 100 and related environment for the generation, storage and use of a soft body file, in accordance with some embodiments of the present disclosure. Computer system 100 may be any computer system or device, including desktop computers and portable electronic devices such as smartphones, tablet computers and laptops. Computer system 100 is used to generate a soft body file 200 (see FIG. 2) for storing information for simulating a three-dimensional object to be projected on a two-dimensional plane. In some embodiments, the three-dimensional object may be a soft body object, including any soft or pliable material, including but not limited to cloth, fabric, and textiles. In some embodiments, the three-dimensional object may be made of at least one component or piece. In some embodiments, the three-dimensional object may be used for the physical production of an article drawn up in a CAD program, for example, through the production of clothing items, such as clothing.

According to some embodiments, computer system 100 may comprise at least one computer processor 102, and at least one memory 104. The at least one computer processor 102 may include at least one processing unit and may be configured to execute programmed computer-executable instructions that are stored in the at least one memory 104. In some embodiments, the computer processor may run one or more modules, such as a soft body file generation module 106, a soft body file reading module 108, and a simulation module 110. In some embodiments, soft body file generation module 106 may be used to generate the soft body file 200. The process of generating of the soft body file 200, according to some embodiments of the present disclosure, provides for an occupancy grid-based topology array of vertices approach resulting in the decrease of data that is required to be stored in order to accurately simulate the soft body object or physically produce the soft body object.

In some embodiments, soft body file reading module 108 may be used to read the soft body file 200. In some embodiments, simulation module 110 may be used to simulate a three-dimensional object based on the soft body file 200 that was read by the soft body file reading module 108. In some embodiments, the simulation module 110 comprises the soft body file reading module 108.

In some embodiments, the at least one memory 104 may be a volatile or non-volatile memory and may comprise data storage 112 and/or program memory 114. A person skilled in the art will understand that the term “non-volatile memory” or “byte addressable memory” refers to a memory that is able to retain contents stored therein even at power-off. Whereas “volatile memory” refers to a memory capable of reading and writing operations, while the contents stored therein may be lost when the power is switched off. In some embodiments, the at least one computer processor 102 may be connected to the volatile memory and the non-volatile memory. Data storage 112 may store an executable version of a software useful to practice the techniques and methods described in the present disclosure. Data storage 112 may be included in the at least one memory 104 or may be separate from the at least one memory 104.

In some embodiments, the at least one memory 104 may interact with the at least one computer processor 102. In some embodiments, the at least one memory 104 may be used to store an executable version of a software, or computer application useful to practice the techniques and methods described in the present disclosure.

In some embodiments, graphics processing units (GPUs) 116, each of which may comprise of several computing processors, may be used to perform any of the steps associated with the simulating of the soft body object. In some embodiments, the GPU(s) 116 may be used to store an executable version of a software, or computer application useful to practice the techniques and methods described in the present disclosure. The use of GPUs 116 having multiple processors may enable faster processing, though it is to be realized that with the saving and proposed by the present disclosure, significant storage size can be made available to increase processing of the soft body file 200 resulting in a more realistic simulation of the soft body object or a more accurate production of a physical article based on the soft body object as stored in the soft body file.

According to some embodiments, computer system 100 may further comprise an I/O interface 118 to transfer information between computer system 100 and external devices such as a display 120, a keyboard 122 and/or a selection device 124. Display 120 generally operates to provide a presentation of content, such as the two-dimensional plane on which the simulated three-dimensional object is projected on. In some embodiments, display 120 may be any computer monitor or screen. In some embodiments, computer processor 104 may communicate with display 120 to project the simulated three-dimensional object on said display 120. In some embodiments, the three-dimensional object may be a pixel array to be projected on screen or display 120. In some embodiments, selection device 124 may be any input or pointing device for a user to input information, data, or instructions for operation of computer system 100, including a mouse or a touch display integrated with display 120. In some embodiments, computer system 100 may further comprise a network interface or adapter 126 to connect to a local network or a wireless network.

In some other embodiments, computer system 100 may be further in communication (direct or indirect) with a cloth cutting unit 130, which may comprise of a cloth and fabric cutting machine, such as for example, a fabric laser cutting machine, or a fabric water-jet cutting machine or a knife cutting machine, such as Talon 25X by Eastman, Buffalo, New York. The cloth cutting unit 130 may comprise a cloth cutting module 132 for receiving the soft body file 200 generating a soft body object (or other necessary output) from said soft body file 200 and proceed to cutting a piece of fabric (not shown) based on the soft body objects generated from the data stored in the soft body file 200. It will be appreciated that, in some embodiments, the cloth cutting machine 130 may be used independently of the computer system 100 such that the soft body file 200 is transferred to the cloth cutting unit 130 via a computer readable storage medium, now existing or later developed and is processed by cloth cutting module 132.

It should be recognized that the software functionality described in FIG. 1 is exemplary and that the functions described herein may be implemented in hardware, software, firmware, or any combination thereof. If implemented in software, the functions may be stored on, or transmitted as, one or more instructions or code encoded on a non-transitory computer-readable medium. According to some embodiments, the methods described within the present disclosure may be stored as instructions on the computer-readable medium to await execution by a computer system.

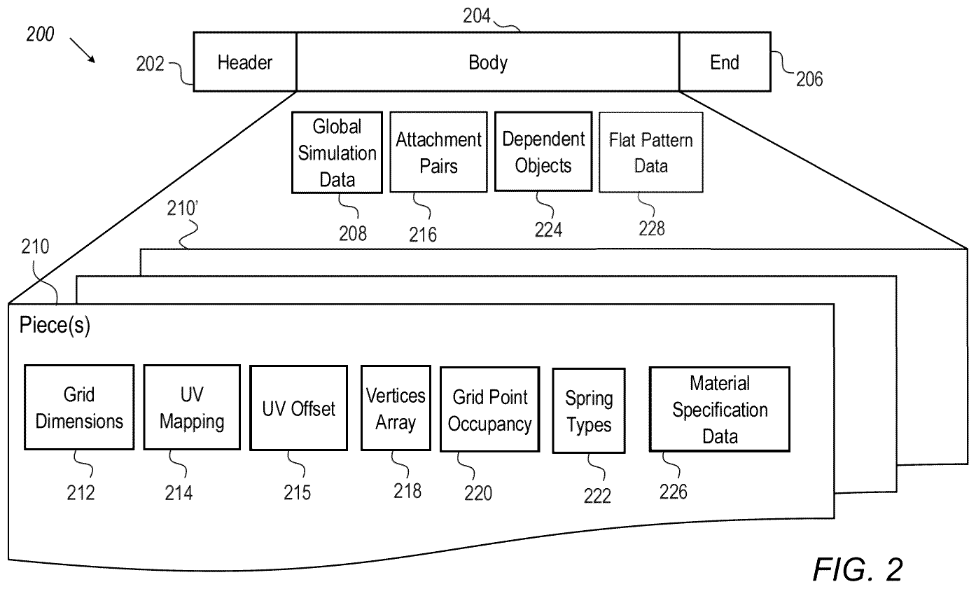

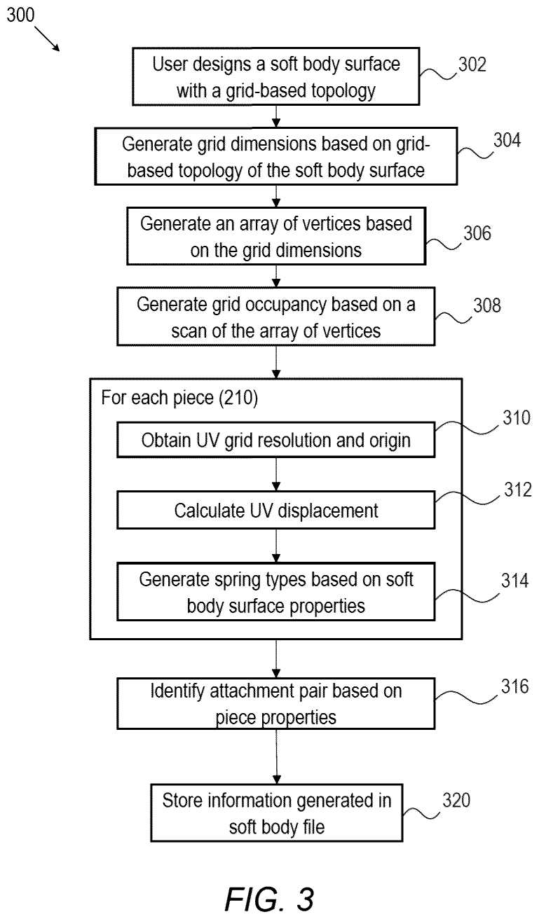

FIG. 2 is a schematic illustration of an example of a structure of a soft body file 200 storing data for simulating a three-dimensional object to be projected on a two-dimensional plane or to be used for the production of clothing article, and FIG. 3 is a schematic illustration of a process of generating a body portion of the soft body file 200, according to embodiments of the present disclosure. The three-dimensional object to be simulated and projected may comprise a soft body surface and a grid-based topology. In some embodiments the soft body surface is a representation of the surface of a three-dimensional object. In some embodiments, the three-dimensional object may be a woven material or fabric made by interlacing two or more threads at right angles to one another, having a structure that is generally grid-like. Most apparel articles are woven or knit and other materials with uniform characteristics in every direction, such as felt and latex may be simulated with a grid topology by having the same springs defined for every direction and/or saved in a grid topology to enable additional storage saving.

In some embodiments, the structure of the soft body file 200 may provide data storage size savings and/or enable faster processing of the soft body objects by the processor(s) 102 of the computer system 100, may enable faster transfer of the soft body file 200 through a communications network; and may provide a more realistic simulation of the soft body object on the display 120 or a more accurate production of a physical article based on the soft body object stored in the soft body file 200. In some embodiments, the soft body object is a 3D object to be stored in the soft body file 200.

According to some embodiments, the soft body file 200 may comprise a header portion 202, a body portion 204, and an end portion 206. Header portion 202 comprises information relating to the file format, as well as metadata about the file and its content, and provides information that is necessary to read the information in the body portion 204 of the soft body file 200. Header portion 202 may further comprise information on whether any of the data contained within the soft body file 200 refers to an external file that may be required. External files that may be required include mesh files and information on parent object hierarchy. Header portion 202 may also comprise information relating to the number of sub objects or pieces in the soft body file 200. In some embodiments, header portion 202 may also comprise information on a mesh compression method used.

According to some embodiments, the body portion 204 of the soft body file 200 may comprise information on the three-dimensional object to be stored and later extracted and simulated or used for a more accurate production of a physical article. In some embodiments, the three-dimensional object to be simulated may comprise an at least one piece 210, the at least one piece 210 making up the three-dimensional object. In some embodiments, different pieces 210, 210′ may represent different fabrics having different linear elastic properties, such as stretch, density, thickness, thermal, conductivity, permeability and the like. It will be understood that different types of fabric, such for example, wool and cotton, would present different linear elastic properties and therefore would be stored as a separate piece. In some embodiments, body portion 204 of the soft body file 200 may comprise information on the at least one piece 210 that makes up the three-dimensional object. In some embodiments, each at least one piece 210 may comprise the at least one piece 210 grid dimensions 212. In some embodiments, each at least one piece 210 may comprise the at least one piece 210 global simulation data 208. In some embodiments, each at least one piece 210 may comprise the at least one piece 210 UV mapping 214. In some embodiments, each at least one piece 210 may comprise the at least one piece 210 UV offset 215. In some embodiments, each at least one piece 210 may comprise the at least one piece 210 attachment pairs 216. Attachment pairs 216 may relate to one or more of the at least one piece 210, 210′. In some embodiments, each at least one piece 210 may comprise the at least one piece 210 vertices array 218. In some embodiments, each at least one piece 210 may comprise the at least one piece 210 grid point occupancy 220. In some embodiments, each at least one piece 210 may comprise the at least one piece 210 spring types 222. In some embodiments, each at least one piece 210 may comprise the at least one piece 210 dependent objects 224. In some embodiments, the dependent object 224 may relate to the at least one piece 210, 210′. In some embodiments, each at least one piece 210 may comprise the at least one piece 210 material specification data 226. In some embodiments, each at least one piece 210 may comprise the at least one piece 210 flat pattern data 228. In some embodiments, the body portion 204 of the soft body file 200 may be generated by soft body file generation module 106 according to a process 300 based on a design by a user (see FIG. 3). The use of the term relate may indicate an association, connection, reference, indication and is used in a non-limiting way.

Referring now to FIG. 3, according to some embodiments, process 300 may begin with operation 302 wherein the user designs a soft body surface with a grid-based topology. Such design of the soft body surface, which may be a part of the soft body object, may be implemented using a CAD application operating on computer system 100 of FIG. 1. The design may be accomplished by the designer using selection device 124 of FIG. 1 and selecting a material having different characteristics, such as for example, those corresponding to wool or cotton, leather, or silk and so forth. In some embodiments, the designer, using the CAD features of “drag and pull” to model two-dimensional or three-dimensional surfaces presented to the designer by the CAD program on the computer system display 120, the two dimensional or three-dimensional surfaces are provided with grid-based topology after generating the surface's UV mapping and from boundary of said UV mapping rewriting the object's surface in the grid topology based on a selected material.

The designer may select, change, and amend the 2D or 3D surface or its UV mapping or UV boundary attachment by using the selection device 124. In some embodiments, the designer may define the characteristics of the material linear elastic and other properties, such as for example, fiber or filament, yarn, weight, thickness, fabric structure, warp, weft, wale, width, intensity, tension, shading, permeability, heat transmission, tear strength, tensile strength, resistance, edges or attachments strength, bending stiffness, stretch stiffness (warp/weft) and so forth. In some embodiments of the disclosure, the material linear elastic and other properties are the properties of the soft body surface.

According to some embodiments, process 300 may continue with operation 304 wherein the at least one processor 102 may generate grid dimensions 212 based on the grid-based topology of the soft body surface designed by the user. In some embodiments, the grid dimensions 212 of the grid-based topology may comprise at least two parameters selected from the group of parameters comprising: a total number of grid points; a total number of rows; and a total number of columns. In some embodiments, the grid dimensions 212 of the grid-based topology may comprise at least two parameters selected from the group of parameters consisting of: a total number of grid points; a total number of rows; and a total number of columns. The grid points represent points of intersection between the rows and the columns. In some embodiments, the grid dimensions 212 may comprise a total number of grid points and a total number of rows. In some embodiments, the grid dimensions 212 may comprise a total number of grid points and a total number of columns. In some embodiments, the grid dimensions 212 may comprise a total number of rows and a total number of columns. In some embodiments, the grid dimension 212 may comprise a total number of grid points, a total number of rows and a total number of columns. In some embodiments, the grid points, represent all the necessary point to capture the soft body surface of the grid-based topology. In some embodiments, the grid dimensions may be changed based on the material selected for the piece. For example, when the cloth resolution for the material selected is smaller, the grid dimensions 212 would be increased, such that the bounding box of the piece in its UV mapping would be the grid dimensions 212 multiplied by the cloth resolution. The bounding box is the coordinates of the rectangular border that fully encloses the piece's UV mapping. In some embodiments, the grid dimensions 212 are determined as the bounding box divided by the cloth resolution. The bounding box may be changed through changes in the shape, rotation or scale of the piece in its UV mapping. In some embodiments, the grid dimensions 212 is stored to the soft body file 200.

According to some embodiments, process 300 may continue with operation 306 wherein the at least one processor 102 may generate one or more array of vertices 218 of the at least one soft body surface of the three-dimensional object to be simulated, based on the grid dimensions 212, of the at least one piece 210. The vertices represent discrete points on the soft body surface of the three-dimensional object. In some embodiments, a mass for each vertex in the array of vertices 218 may be derived from the material density of the 3D object to be simulated. In some embodiments, each vertex in the array of vertices 218 may have a position, the position may be stored as a float data type. The position may represent a 3D position in a coordinate system. In some embodiments, mass of a vertex may capture the material properties of the surface of the three-dimensional object to be simulated, while the vertex may capture the form of the surface of the simulated three-dimensional object. In some embodiments, the array of vertices 218 is stored to the soft body file 200.

According to some embodiments, process 300 may continue with operation 308 wherein the at least one processor may generate an array of grid occupancy 220 of the grid-based topology for the array of vertices 218 based on a scan of the array of vertices 218. Each vertex of the array of vertices 218 has a discrete position on the grid dimensions 212 of the grid-based topology. In some embodiments, when a change in the selected material would also lead to a change of cloth resolution, the array of grid occupancy 200 comprises grid points. The array of grid occupancy 200 may also be referred to as the grid point occupancy array. A grid point where a vertex is located is said to be occupied; and the grid point occupancy array 212 represents the grid points occupied by the vertices on the grid-based topology. In some embodiments, the grid point occupancy array 220 may have a first number that indicates whether the first grid point is occupied or unoccupied. In some embodiments, the array of grid point occupancy 220 may comprise an array of numbers alternating between a number of consecutive grid points that are occupied and a number of consecutive grid points that are unoccupied when all grid points are collated or scanned column by column or row by row. In some embodiments, the collation or scanning may happen from top to bottom, or bottom to top. In some embodiments, the first number of the array of grid point occupancy may be 0 when the first grid point is occupied and may be 1 when the first grid point is unoccupied. In some embodiments, the second number of the array of grid point occupancy may represent the number of consecutive grid points including the first grid point that are occupied or unoccupied, depending on whether the first grid point is occupied. In some embodiments, the third number may then represent the number of consecutive grid points that are unoccupied or occupied, depending on what the preceding second number represents. In some embodiments, the array of grid occupancy 220 is stored to the soft body file 200.

In embodiments where the first grid point is occupied, the second number may represent the number of consecutive grid points including the first grid point that are occupied, the third number may represent the number of consecutive grid points that are unoccupied, and so on. In embodiments where the first grid point is unoccupied, the second number may represent the number of consecutive grid points including the first grid point that are unoccupied, the third number may represent the number of consecutive grid points that are occupied, and so on.

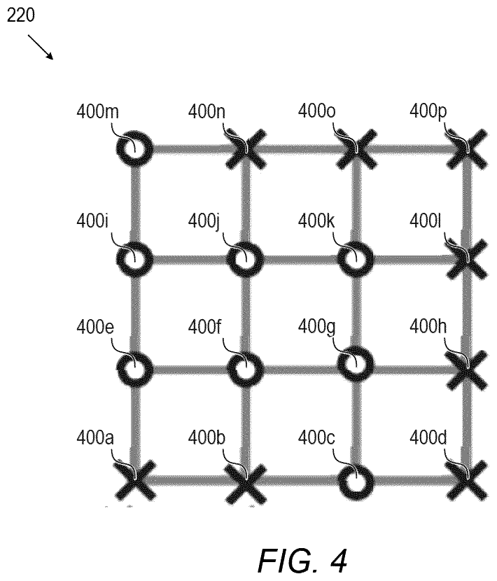

FIG. 4 is a schematic illustration of an example of the array of grid point occupancy 220 with some occupied grid points, in accordance with embodiments of the present disclosure. Grid 400 comprises grid points 400a . . . p. Each grid point 400a . . . p is illustrated with a circle or a cross, with circles representing occupied grid points and crosses representing unoccupied grid points. In the example of the array of grid point occupancy 220 the collation or scanning takes place row by row, from bottom to top is as follows:
[0, 2, 1, 1, 3, 1, 3, 1, 1, 3]

The first number is 0 as the first grid point 400a is unoccupied. The second number is 2 as two consecutive grid points, first grid point 400a and second grid point 400b, are unoccupied. The third number is 1 as the following grid point, third grid point 400c, is occupied. The fourth number is 1 as the following grid point, fourth grid point 400d, is unoccupied. The fifth number is 3 as the following three consecutive grid points, fifth grid point 400e, sixth grid point 400f and seventh grid point 400g, are occupied. The sixth number is 1 as the following grid point, eighth grid point 400h, is unoccupied. The seventh number is 3 as the following three consecutive grid points, ninth grid point 400i, tenth grid point 400j and eleventh grid point 400k, are occupied. The eighth number is 1 as the following grid point, twelfth grid point 400l, is unoccupied. The ninth number is 1 as the following grid point, thirteenth grid point 400m, is occupied. The last number is 3 as the following three consecutive grid points, fourteenth grid point 400n, fifteenth grid point 400o and sixteenth grid point 400p, are unoccupied. By storing the array of grid point occupancy 220 on soft body file 200 instead of information on every grid point in the grid-based topology that may be present, the soft body file 200 will have a smaller resulting file size.

According to some embodiments, process 300 may continue with operations 310 through 316 wherein the at least one processor 102 may define certain parameters for each piece 210. In some embodiments, process 300 may continue with operation 310 wherein the at least one processor 102 may obtain a UV mapping resolution and UV mapping origin for each piece 210 or a UV grid resolution and origin for each piece 210. The UV mapping resolution and origin are information used to generate UV mapping 214. UV mapping 214 generation involves mapping a 2D texture onto the surface of the simulated three-dimensional object. In some embodiments, the UV mapping 214 may have an origin based on the grid-based topology of the three-dimensional object. The UV mapping origin is the translation of the piece's entire UV map. In some embodiments, the UV mapping resolution may have a scale of each cell based on the grid-based topology, a cell being a space between four intersecting grid lines and accordingly storage space is saved since there is no need to store the 2D coordinates for each vertex. The UV mapping 212 may contain the UV mapping origin and the UV map resolution. In some embodiments, the UV mapping 214 data is stored to the soft body file 200. In some embodiments, the soft body file 200 may further comprise a UV mapping origin based on the grid-based topology, a UV mapping resolution of a scale of each cell based on the grid-based topology and at least one UV offset comprising an element in the array of vertices and an clement UV coordinate.

According to some embodiments, processor 102 may continue with operation 312 wherein the at least one processor 102 may calculate a UV offset or UV displacement to define at least one UV offset or UV displacement 215, UV offset 215 comprising an element in the array of vertices and an element UV coordinate. Each element in the array of vertices represents each vertex's identification. UV offset 215 may be calculated to enhance the accuracy and/or realism of the three-dimensional object being simulated or to be physically manufactured from the soft body file. In some embodiments, the element may be an identification of a vertex on surface's UV mapping 214. In some embodiments, each said element in the array of vertices 218 may have a coordinate, also known as an element UV coordinate, describing a position of the element on the UV mapping 214. In some embodiments, the element UV coordinate may be a two-dimensional vector, the two-dimensional vector being the position of the previously identified vertex in the surface's UV mapping 214, or the grid-topology of the three-dimensional object. In other embodiments, the element UV coordinate may be a position where the element is added to the two-dimensional point of a corresponding grid point in two-dimensional space. In other words, the element UV coordinate may be a two-dimensional vector being the position of the vertex in the surface's UV mapping 214 when added to the two-dimensional position of the vertex's corresponding grid point, the two-dimensional position of the grid point resulting from the grid's position at grid origin and scaled to grid resolution. In some embodiments, the UV offset 215 data is stored to the soft body file 200.

According to some embodiments, process 300 may continue with operation 314 wherein the at least one processor 102 may generate one or more spring types 222 for each piece 210 based on one or more surface properties of the soft body surface. A spring refers to a constraint or a relationship between a first particle and a second particle. Various types of springs, or constraints or relationships, may exist between any two vertices and used in the context of the present disclosure. In some embodiments, springs may represent constraints or relationships that may exist within the real-life counterpart of the simulated three-dimensional object. For example, a cloth material may have structural, shear and flexion (or bend) springs to define the relationships or constraints between vertices of the cloth material. In some embodiments, substantially all cloth behaviour may be captured within one or more spring types or the combination thereof which may be combined with the UV resolution. The one or more spring types 222 is common to all vertices within a piece and defines all the relationships between vertices that might be present within a piece. By storing spring type 222 information on soft body file 200 instead of information on every spring that may be present in the soft body surface, the soft body file 200 will have a smaller resulting file size. In some embodiments, the sprint type 222 data in relation to the at least one piece 216 is stored to the soft body file 200.

In some embodiments, soft body file reading module 108 and simulation module 110 may use spring type 222 information to populate springs for each vertex. In some embodiments, the use of sprint types provides a significant saving in data storage since 6 or 8 spring types each being 12 to 20 bytes is required in accordance with the disclosure. The lower end of the range is equal to 6*12 bytes, that is 72 bytes, and the upper end of the range is equal to 8*20 bytes, that is 160 bytes. This is constant and does not grow with N. In contrast, saving all the springs would require about 6 to 8 springs from each vertex (to another vertex), and N vertices (N being the number of vertices). Accordingly, the number of springs would be 6N to 8N. Each spring having two vertices (vertex1 index (saved as an integer with 4 bytes), vertex2 index (saved as an integer with 4 bytes), a rest length (saved as float (or double) with 4 bytes), and possibly a minimum length and maximum length (saved as float (or double) with 4 bytes each). Therefore, each spring would require 12 to 20 bytes of storage. The lower end of the range would be equal to 12*6N, that is 72N bytes; the upper end of the range would be equal to 20 *8N bytes, that is 160N bytes, where N has of magnitude of 103, 104, or higher.

According to some embodiments, each spring type 222 may be defined by a vector on the grid-based topology and a spring definition. In some embodiments, each spring type 222 may comprise a vector on the grid-based topology and a spring definition. In some embodiments, the vector may comprise a first number which represents the distance along the x-axis between the two vertices constrained by the spring and a second number which represents the distance along the y-axis between the two vertices constrained by the spring. The first number and second number of the vectors may be positive or negative to represent the direction of the second vertex with respect to the first vertex. In some embodiments, a structural spring may have a vector (0, 1), indicating that the first vertex and the second vertex have the same position along the x-axis, and the second vertex is one grid point away from the first vertex along the y-axis. In some embodiments, a shear spring may have a vector (1, 1), indicating that the second vertex is one grid point away from the first vertex along the x-and y-axis. In some embodiments, a flexion or bend spring may have a vector (2, 0), indicating that the second vertex is two grid points away from the first vertex along the x-axis, and have the same position as the first vertex along the y-axis.

According to some embodiments, the spring definition may define a distance constraint between two vertices. In some embodiments, the spring definition may comprise a distance constraint between two vertices of the at least one array of vertices of the at least one body surface. In some embodiments, the spring definition may be stored as a double data type. In some embodiments, the spring definition may comprise a rest length, a minimum length, and a maximum length. In some embodiments, the rest length may be the initial distance between two vertices. In some embodiments, the rest length may be independent of the material being simulated. In some embodiments, the minimum length and maximum length may indicate an allowable range for the distance between two vertices during simulation. In some embodiments, the minimum length and maximum length may be a function of the material being simulated. In some embodiments, the rest length may be stored independently of the minimum length and the maximum length so that the material being simulated may be changed, such that the minimum and maximum length may be recalculated as multiples of the rest length according to the selected material. In some embodiments, the rest length, minimum length, and maximum length may be stored as squared values to improve computation speed.

According to some embodiments, process 300 may continue with operation 316 wherein the at least one processor 102 may identify at least one attachment pair 216 based on each piece 210 properties. The at least one attachment pair 216 identifies two vertices of the array of vertices that are not adjacent to each other on the two-dimensional plane but are attached to each other on the three-dimensional object or may represent an attachment point on a physical embodiment of the at least one piece 210, for example, on a piece of cloth to be cut by the cloth cutting machine 130. In some embodiments, the soft body file 200 may further comprise at least one attachment pair 216, the at least one attachment pair 216 may define two vertices of the at least one array of vertices that are not adjacent to each other on the two-dimensional plane but are attached to each other on the three-dimensional object. In some embodiments, the at least one attachment pair 216 does not include any distance constraints as the distance between the two vertices is always zero. In some embodiments, the vertices defined by the at least one attachment pair 216 are located at a border or edge of a piece. In some embodiments, the at least one attachment pair 216 data is stored to the soft body file 200.

According to some embodiments, process 300 may end with operation 320 wherein the at least one processor 102 may store the data generated in operations 304 to 316 in the soft body file 200.

According to some embodiments, processor 102 may further include global simulation data 208 based on user input provided, for example, through a CAD program within the soft body file 200 or based on pre-set parameters set within a simulation software, CAD program pre-set parameters, and the like. Global simulation data 208 may comprise simulation parameters that apply to all pieces of a three-dimensional object and is used for engine compatibility. An engine generating the soft body file 200 stores the global simulation data 208 such that an engine receiving the soft body file 200 may use the global simulation data 208 to simulate the three-dimensional object in similar conditions as that of the generating engine such that the simulated object exhibits behaviour to that simulated by the generating engine. In some embodiments, global simulation data 208 may comprise information on constants such as gravity and time step, such for example, 1/10 s, 1/50 s, 1/100 s, 1/200 s, and so forth. In some embodiments, global simulation data 208 may comprise code for a type of partial differential equation (PDE) or integration. In some embodiments, global simulation data 208 may comprise information on the type of processor unit employed, such as whether a central processing unit (CPU) or a graphics processing unit (GPU) is employed.

According to some embodiments, processor 102 may further process and store information on at least one relationship between at least one dependent object 224 and the soft body surface of the simulated three-dimensional object within the soft body file 200. The at least one dependent object 224 may be any additional object that may be attached, affixed, or otherwise connected to the soft body material surface of the simulated three-dimensional object. In embodiments where the simulated three-dimensional object is clothing, the at least one dependent object 224 may be a button, zipper, applique, or trim, an insert pocket and any other element that is not expected to distort the surface. The at least one dependent object 224 may be defined with a mass, a piece to which it is attached to, and one or more the vertices to which it is attached. In some embodiments, the geometry of the at least one dependent object 224 does not themselves undergo simulation but will be updated by the piece to which the at least one dependent object 224 is attached to. In some embodiments, the at least one dependent object 224 may be attached to the piece at a single point (e.g., a button), such that the entire at least one dependent object 224 is subject to one transformation based on the at least one piece 210 to which the at least one dependent object 224 is attached to. In some embodiments, the at least one dependent object 224 may be attached to the at least one piece 210 along a line (c.g., a zipper), or over an area (e.g., an applique), such that each vertex to which the at least one dependent object 224 is attached to is updated independently.

According to some embodiments, at least one relationship between the at least one dependent object 224 and the soft body surface comprises a position on the soft body surface based on three or more vertices of the array of vertices. As the at least one dependent object 224 would typically be attached to one or more vertices on the soft body material, the position of the at least one dependent object 224 would need to be mapped onto a vertex based the vertices to which the at least one dependent object 224 is attached to. In some embodiments, the relationship may be based on three vertices, such that the position of the vertex mapped onto is based on a triangular patch formed by the three vertices, given a barycentric coordinate and a normal offset vector. In some embodiments, the relationship may be based on four vertices, such that the position of the vertex mapped onto is based on a quadrilateral patch formed by the four vertices, given a 2d coordinate and a normal offset vector. In some embodiments, the at least one dependent object 224 data is stored to the soft body file 200.

According to some embodiments, processor 102 may further process and store a material specification data 226 representing physical properties of a soft body material to be stored in the soft body file 200. In some embodiments, the material specification data 226 may be stored as a double data type. In some embodiments, material specification data 226 may comprise a bending property of the soft body material in the warp direction, and a bending property of the soft body material in the weft direction. In some embodiments, material specification data 226 may comprise a stretching property of the soft body material in the warp direction, and a stretching property of the soft body material in the weft direction. In some embodiments, material specification data 226 may comprise a shearing property of the soft body material. In some embodiments, material specification data 226 may comprise a friction coefficient of the soft body material, which may describe the slipperiness or smoothness of the soft body material. In some embodiments, material specification data 226 may comprise a thickness property of the soft body material. In some embodiments, material specification data 226 may comprise a mass property of the soft body material.

According to some embodiments, processor 102 may further process and store a flat pattern data 228 in the soft body file 200. The flat pattern data 228 comprises boundary information of the at least one piece 210, that is the subsets of the boundaries to be joined during simulation or stitching or connecting to form a clothing article. For example, it is useful in sourcing scenarios to evaluate the viability of a substitute or alternative material for production, in cases where a production-ready design is to be produced at facilities without access to the original material, or where the producer wants to use other material that may be stocked. It is also useful in virtual scenarios, to substitute the material and cloth topology in cloth simulation engines that may have a lower resolution or accuracy. In the context of soft material articles, the flat pattern is often used since in most cases soft materials such as cloth is cut from flat shapes or patterns and then assembled by joining their boundaries.

According to some embodiments, the flat pattern data 228 may comprise at least one boundary curve having two subsets, wherein the at least one boundary curve comprises an array of elements of the array of vertices of the soft body surface. In some embodiments, the flat pattern data 228 may include at least one boundary curve having two subsets, wherein the at least one boundary curve comprises an array of elements of the at least one array of vertices of the at least one soft body surface. The at least one boundary curve may represent a border or perimeter of each piece. In some embodiments, the flat pattern data 228 may further comprise an at least one boundary segment pair of the two subsets of the at least one boundary curve, wherein the two subsets of the at least one boundary curve are to be attached in three-dimensional space. The at least one boundary segment pair may represent specific parts of the boundary curve that are coincident in 3D, but not in 2D.

### EXAMPLES

The following examples are provided to illustrate the present disclosure and should not be construed as limiting thereof. Various file sizes and structures of existing three-dimensional modelling files and the soft body file of the present disclosure are compared to illustrate some of the space-saving and structure benefits of the soft body file 200, the apparatus and methods of the present disclosure.

Existing or commonly used three-dimensional modelling files include STL, and OBJ. Other structures may comprise presently known files in addition to other structures used for the purpose of illustration and demonstration of the benefits of the present disclosure. In all the examples below, “N” represents the number of vertices, “P” represents the number or pieces, “√” is a square root operation, “+” is an addition operation, “/” is a division operation and “*” is a multiplication operation. Normals is the direction each vertex is facing (one normal for each vertex). Faces represent data on three or more edges, and for each edge two connected vertices, the edges forming a face that may be filled and makes up what is visible on a polygon mesh. The comparison made to an OBJ file to which springs are added is denoted by a “˜” since in practice, at the time of this disclosure, OBJ files and other files listed below do not include springs. It should be appreciated that some of the modelling data provided is not presently being used in currently existing files and said date is provided to illustrate the benefits of the present disclosure.

OBJ is a file format developed by Wavefront Technologies, Santa Barbara, California, that comprises mesh and texture mapping. However, an OBJ file does not comprise spring information on the material that comprises the object being simulated. The variables that contribute to the file size include vertices, normals, UV, and faces. The variables contributing of the file size of an OBJ file are illustrated below in Table 1. Based on Table 1 below, the file size for a minimal OBJ comprising vertices, normals, UV and faces (min) is 64N bytes, and the file size for a maximal OBJ comprising vertices, normals, UV and faces (max) is 112N bytes.

TABLE 1
Variables Contributing to File Size of OBJ

| | | Unit | Qty | Total |
|---|---|---|---|---|
| | | size | per | size |
| | Type | (bytes) | vertex | (bytes) |
| Vertices | float4 | 16 | 1 | 16N |
| Normals | float3 | 12 | 1 | 12N |
| UV | float3 | 12 | 1 | 12N |
| Faces (min) | Int, int, int | 12 | ~2 | 24N |
| Faces (max) | Int3, int3, int3 | 36 | ~2 | 72N |

STL is a file format native to the stereolithography CAD software created by 3D Systems, Santa Clarita, California, that only comprises information on a 3D model without texture. An STL file does not comprise information on UV mapping or spring information on the material that comprises the object being simulated. The variables that contribute to the file size are triangles comprising vertices. The variables contributing of the file size of a STL file are illustrated below in Table 2. Based on Table 2 below, the file size for an STL file is 100N bytes.

TABLE 2
Variables Contributing to File Size of STL

| | | Unit | Qty | Total |
|---|---|---|---|---|
| | | size | per | size |
| | Type | (bytes) | vertex | (bytes) |
| Triangles | | 50 | ~2 | 100N |
| comprising: | | | | |
| i. normal vector | i. REAL32[3] - | | | |
| | 12 bytes | | | |
| ii. vertex 1 | ii. REAL32[3] - | | | |
| | 12 bytes | | | |
| iii. vertex2 | iii. REAL32[3] - | | | |
| | 12 bytes | | | |
| iv. vertex3 | iv. REAL32[3] - | | | |
| | 12 bytes | | | |
| v. attribute byte | v. UINT16 - 2 bytes | | | |

A soft body simulation model of the present disclosure using a “mass-spring model” comprises, at the minimum, vertices and springs. The variables that contribute to the size are the vertices and springs. The variables contributing of the size of the mass-spring model are illustrated below in Table 3. Based on Table 3 below, the size for a mass-spring model is 108N bytes.

TABLE 3
Variables Contributing to Size of Mass-Spring Model

| | | Unit | Qty | Total |
|---|---|---|---|---|
| | | size | per | size |
| | Type | (bytes) | vertex | (bytes) |
| Vertices | float3 - 12 bytes | 12 | 1 | 12N |
| Springs | uint2 - 4 bytes | 16 | 6 | 96N |
| | float3 - 12 bytes | | | |

The variables contributing of the file size of a soft body file 200 of the present disclosure are illustrated in Table 4. The calculations below assume that the at least one piece 210 are square, such that the number of points on each side or boundary is √(N/P). The number of boundary points per at least one piece 210 is calculated as 5*√(N/P), using 5 instead of 4 to compensate for non-square pieces. Therefore, the total number of boundary points was estimated to be P*(5*√(N/P)). The calculation assumes that the grid point occupancy 220 for the at least one piece 210 is two per grid row, with each grid row being P*√(N/P). The calculation further assumes the presence of 8 springs per point on boundary*(P*(5*√(N/P))) boundary points. The calculation further assumes that half of the boundary points are attached to each other and thus includes (half*half). Based on Table 4 below, the file size for a soft body file 200 of the present disclosure is 12N+116P+(64P*√(N/P)) bytes. The apparatus and methods provided is effective and storage efficient, in view of the description provided herein above, and in addition since face information is not required to be stored and UV is not required to be carried for each vertex.

TABLE 4
Variables Contributing to File Size of Soft Body File

| | | Unit | | Total |
|---|---|---|---|---|
| | | size | | size |
| | Type | (bytes) | Qty | (bytes) |
| Vertices | float3 - 12 bytes | 12 | N | 12N |
| Grid | uint2 - 4 bytes | 4 | P | 4P |
| dimensions | | | | |
| Grid point | uint - 2 bytes | 2 | 2*P*√(N/P) | 2*P*√(N/P) |
| occupancy | | | | |
| UV mapping | float2 - bytes | 16 | P | 16P |
| resolution & | float2 - 8 bytes | | | |
| UV mapping | | | | |
| origin | | | | |
| UV offset | uint - 2 bytes | 10 | P*5(√(N/P)) | 50P*√(N/P) |
| | float2 - 8 bytes | | | |
| Spring | uint2 - 4 bytes | 16 | 6P | 96P |
| types | float3 - 12 bytes | | | |
| Attachment | uint2 - 4 bytes | 8 | P*5(√(N/P))/4 | 10P*√(N/P) |
| pairs | uint2 - 4 bytes | | | |

The file size of the three-dimensional modelling file for a particular format may be calculated based on the number of vertices and/or pieces in the modelling file. The formulae used for calculating the file size for each file format are summarised below in Table 5.

TABLE 5
Formulae for Calculation of Sizes
of Modelling File or Modelling Data

| File | Size Formula (Bytes) |
|---|---|
| Mass-Spring Model | 108N |
| STL | 100N |
| OBJ (max) | 112N |
| OBJ (min) | 64N |
| ~OBJ (max) + Springs | 112N + 96N |
| OBJ (min) + Springs | 64N + 96N |
| Soft Body | 12N + 100P + |
| File 200 | 304P*√(N/P) |

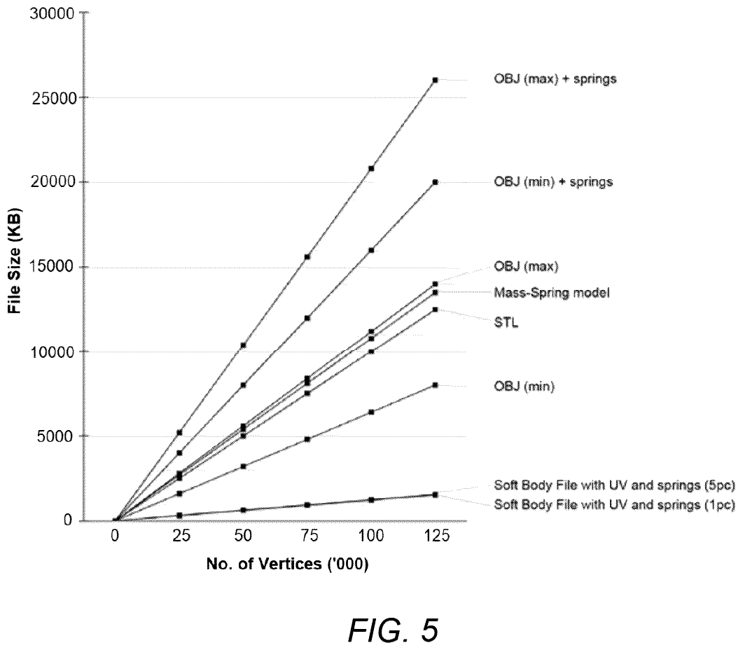

The file sizes of three-dimensional modelling files based on the number of vertices and/or pieces in the modelling file was calculated for each file format and illustrated below in Table 6. FIG. 5 is a graphical representation showing file sizes of modelling files for each file format, in accordance with embodiments of the present disclosure.

TABLE 6
Sizes of Modelling Files and Modelling Data

| | File Size (KB) | | | | | | | |
|---|---|---|---|---|---|---|---|---|
| | Mass | | | | ~OBJ | ~OBJ | Soft | Soft |
| Vertex | Spring | | OBJ | OBJ | (max) + | (min) + | Body file | Body file |
| Count | Model | STL | (max) | (min) | Springs | Springs | (5 pc) | (1 pc) |
| 5,000 | 540 | 500 | 560 | 320 | 1040 | 800 | 71 | 62 |
| 10,000 | 1080 | 1000 | 1120 | 640 | 2080 | 1600 | 135 | 127 |
| 25,000 | 2700 | 2500 | 2800 | 1600 | 5200 | 4000 | 323 | 310 |
| 50,000 | 5400 | 5000 | 5600 | 3200 | 10400 | 8000 | 633 | 614 |
| 75,000 | 8100 | 7500 | 8400 | 4800 | 15600 | 12000 | 940 | 918 |
| 100,000 | 10800 | 10000 | 11200 | 6400 | 20800 | 16000 | 1246 | 1220 |
| 125,000 | 13500 | 12500 | 14000 | 8000 | 26000 | 20000 | 1551 | 1523 |

As illustrated in Table 6 and FIG. 5, the soft body file 200 has a lower file size at all data points. The larger the number of vertices, the more significant the difference in file size as between the tested and observed files and data structures.

The file size of a three-dimensional modelling file consisting only of the form of the 3D model without texture (i.e., without UV mapping, such as UV mapping 214), may be calculated based on the number of vertices and/or pieces in the three-dimensional modelling file. The variables included for calculating the file size of a soft body file 200 with mesh only are illustrated below in Table 7. Based on Table 7 below, the file size of a soft body file 200 without texture (i.e., without UV mapping or spring information) is 12N+4P+4P*√(N/P) bytes.

TABLE 7
Variables Contributing to File Size
of Soft Body File without Texture

| Data | Size (bytes) |
|---|---|
| Vertices | 12N |
| Grid dimensions | 4P |
| Grid point occupancy | 4P*√(N/P) |
| TOTAL | 12N + 4P + |
| | 4P*√(N/P) |

The formulae used for calculating the file size of a three-dimensional modelling file without texture for the STL and soft body file format are summarised below in Table 8.

TABLE 8
Formulae for Calculation of File Size
of Modelling Files without Texture

| File | Size (bytes) |
|---|---|
| STL | 100N |
| Soft Body File - | 12N + 4P + |
| without texture | 4P*√(N/P) |

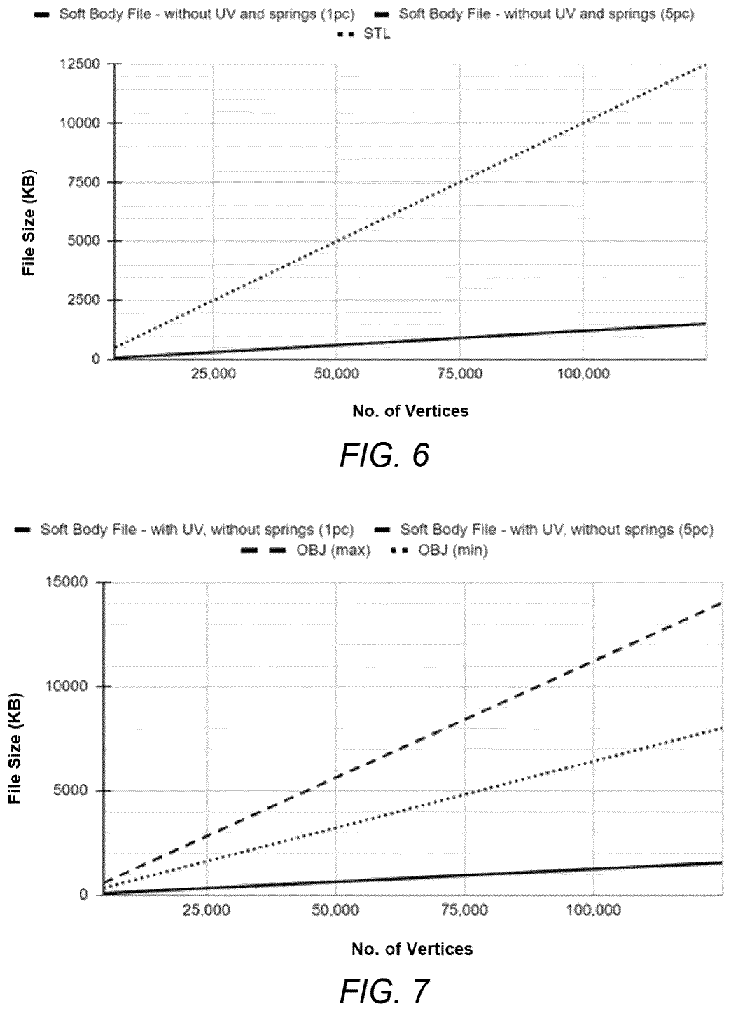

The file sizes of three-dimensional modelling files without texture based on the number of vertices and/or pieces in the modelling file was calculated for each file format and illustrated below in Table 9. FIG. 6 is a graphical representation showing file sizes of three-dimensional modelling files without texture for each file format, in accordance with embodiments of the present disclosure.

TABLE 9
File Sizes of Modelling Files without Texture

| | File Size (KB) | | |
|---|---|---|---|
| | | Soft Body File - | Soft Body File - |
| | | without texture | without texture |
| Vertex Count | STL | (5pc) | (1pc) |
| 5,000 | 500 | 61 | 60 |
| 10,000 | 1000 | 121 | 120 |
| 25,000 | 2500 | 301 | 301 |
| 50,000 | 5000 | 602 | 601 |
| 75,000 | 7500 | 902 | 901 |
| 100,000 | 10000 | 1203 | 1201 |
| 125,000 | 12500 | 1503 | 1501 |

The file size of a three-dimensional modelling file comprising the form of the 3D model with UV mapping information and without spring information may be calculated based on the number of vertices and/or pieces in the three-dimensional modelling file. The variables included for calculating the file size of a soft body file 200 with UV mapping 214 information and without spring information are illustrated below in Table 10. Based on Table 10 below, the file size of a soft body file 200 with UV mapping 214 information and without spring information is 12N+20P+54P*√(N/P) bytes.

TABLE 10
Variables Contributing to File Size of Soft Body File with
UV Mapping Information and Without Spring Information

| Data | Size (bytes) |
|---|---|
| Vertices | 12N |
| Grid dimensions | 4P |
| Grid point occupancy | 4P*√(N/P) |
| UV mapping resolution & | 16P |
| UV mapping origin | |
| UV offset | 50P*√(N/P) |
| TOTAL | 12N + 20P + |
| | 54P*√(N/P) |

The formulae used for calculating the file size of a modelling file with UV mapping information but without spring information for the OBJ and soft body file 200 are illustrated below in Table 11.

TABLE 11
Formulae for Calculation of File Size of Modelling File with
UV Mapping Information but without Spring Information

| File | Size (bytes) |
|---|---|
| OBJ (max) | 112N |
| OBJ (min) | 64N |
| Soft Body File - with UV | 12N + 20P + |
| mapping information and | 54P*√(N/P) |
| without spring information | |

The file sizes of three-dimensional modelling files with UV mapping information but without spring information based on the number of vertices and/or pieces in the modelling file was calculated for each file format and illustrated below in Table 12. FIG. 7 is a graphical representation showing file sizes of three-dimensional modelling file with mesh only for each file format, in accordance with embodiments of the present disclosure.

TABLE 12
File Sizes of Modelling Files with Mesh and UV

| | File Size (KB) | | | |
|---|---|---|---|---|
| | | | Soft Body File - | Soft Body File - |
| | | | with UV mapping | with UV mapping |
| | | | information and | information and |
| Vertex | OBJ | OBJ | without spring | without spring |
| Count | (max) | (min) | information (5pc) | information (1pc) |
| 5,000 | 560 | 320 | 69 | 64 |
| 10,000 | 1120 | 640 | 132 | 125 |
| 25,000 | 2800 | 1600 | 319 | 309 |
| 50,000 | 5600 | 3200 | 627 | 612 |
| 75,000 | 8400 | 4800 | 933 | 915 |
| 100,000 | 11200 | 6400 | 1238 | 1217 |
| 125,000 | 14000 | 8000 | 1543 | 1519 |

The file size of a three-dimensional modelling file comprising the form of a 3D model comprising vertices, UV mapping and spring information may be calculated based on the number of vertices and/or pieces in the three-dimensional modelling file. The variables included for calculating the file size of a soft body file 200 comprising vertices array 218, UV mapping 214, UV offset 214, spring types 222 and attachment pairs 216 information are illustrated below in Table 13. Based on Table 13 below, the file size of a soft body file 200 with mesh only is 12N+116P+64P*√(N/P) bytes.

TABLE 13
Variables Contributing to File Size of Soft Body File
Comprising Vertices, UV Mapping and Spring Information

| Data | Size (bytes) |
|---|---|
| Vertices | 12N |
| Grid dimensions | 4P |
| Grid point occupancy | 4P*√(N/P) |
| UV mapping resolution & | 16P |
| UV mapping origin | |
| UV offset | 50P*√(N/P) |
| Spring Types | 96P |
| Attachment Pairs | 10P*√(N/P) |
| TOTAL | 12N + 116P + |
| | 64P*√(N/P) |

The formulae used for calculating the file size of a three-dimensional modelling file comprising vertices, UV mapping and spring information for the OBJ and soft body file 200 comprising vertices array 218, UV mapping 214, UV offset 214, spring types 222 and attachment pairs 216 information are illustrated below in Table 14.

TABLE 14
Formulae for Calculation of Size of Modelling File or Modelling
Data comprising Vertices, UV Mapping and Spring Information

| File | Size (bytes) |
|---|---|
| ~OBJ (max) + Springs | 112N + 96N |
| ~OBJ (min) + Springs | 64N + 96N |
| Soft Body File - Vertices, UV | 12N + 116P + |
| Mapping and Spring Information | 64P*√(N/P) |

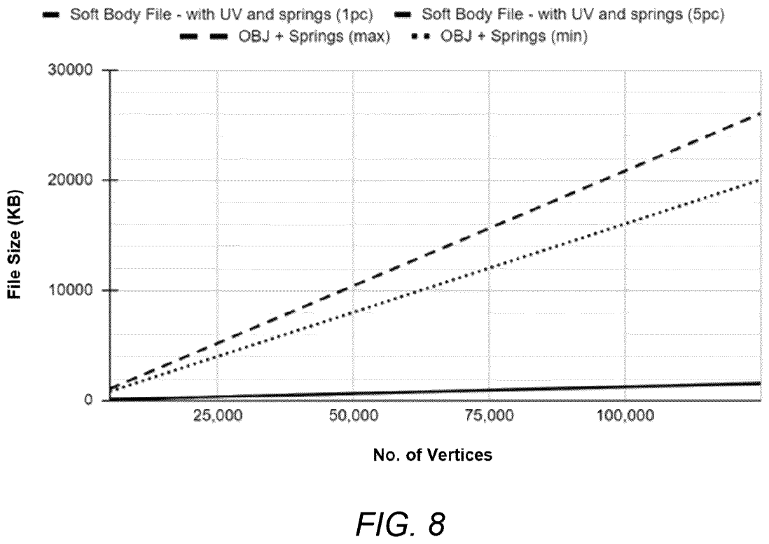

The file sizes of three-dimensional modelling files comprising vertices, UV mapping and spring information based on the number of vertices and/or pieces in the modelling file was calculated for each file format and illustrated below in Table 15. FIG. 8 is a graphical representation showing file sizes of three-dimensional modelling file with mesh only for each file format, in accordance with embodiments of the present disclosure.

TABLE 15
Sizes of Modelling Files or Modelling Data comprising Vertices,
UV Mapping, UV Offset, Attachment Pairs and Spring Information

File Size (KB)

| | ~OBJ | ~OBJ | Soft Body | Soft Body |
|---|---|---|---|---|
| | (max) + | (min) + | File | File |
| Vertex Count | Springs | Springs | (5pc) | (1pc) |
| 5,000 | 1040 | 800 | 71 | 65 |
| 10,000 | 2080 | 1600 | 135 | 127 |
| 25,000 | 5200 | 4000 | 323 | 310 |
| 50,000 | 10400 | 8000 | 633 | 614 |
| 75,000 | 15600 | 12000 | 940 | 918 |
| 100,000 | 20800 | 16000 | 1246 | 1220 |
| 125,000 | 26000 | 20000 | 1551 | 1523 |

As is also seen, normals are not required to be stored within the soft body file of the present disclosure. In some embodiments, normals may be obtained from faces, which may be generated from the grid topology.

It should be appreciated that the above-described methods and apparatus may be varied in many ways, including omitting, or adding steps, changing the order of steps and the type of devices used. It should be appreciated that different features may be combined in different ways. In particular, not all the features shown above in a particular embodiment are necessary in every embodiment of the disclosure. Further combinations of the above features are also considered to be within the scope of some embodiments of the disclosure.

It will be appreciated by persons skilled in the art that the present invention is not limited to what has been particularly shown and described hereinabove. Rather the scope of the present invention is defined only by the claims, which follow.

1. An apparatus, having a computer processor, a volatile memory, a non-volatile memory, the computer processor connected to the volatile memory and the non-volatile memory, the computer processor executing computer-executable instructions for generating a soft body file for storing information for simulating a three-dimensional object to be projected on a two-dimensional plane, the three-dimensional object having an at least one soft body surface and a grid-based topology, the soft body file comprising: a header portion, a body portion and an end portion, the body portion comprising an at least one array of vertices of the at least one soft body surface; a grid dimension of the grid-based topology; and an array of grid point occupancy of the grid-based topology for the at least one array of vertices of the at least one soft body surface.

2. The apparatus of claim 1, wherein the grid dimension of the grid-based topology comprises at least two parameters selected from the group of parameters consisting of:
a total number of grid points;
a total number of rows; and
a total number of columns.

3. The apparatus of claim 1, wherein the array of grid point occupancy comprises an array of numbers alternating between a number of consecutive grid points that are occupied and a number of consecutive grid points that are unoccupied when all grid points are scanned column by column or row by row.

4. The apparatus of claim 1, wherein the three-dimensional object is a pixel array to be projected on a screen.

5. The apparatus of claim 1, wherein the soft body file further comprises a global simulation data.

6. The apparatus of claim 1, wherein the soft body file further comprises spring types, each spring type comprising a vector on the grid-based topology and a spring definition.

7. The apparatus of claim 6, wherein the spring definition comprises a distance constraint between two vertices of the at least one array of vertices of the at least one soft body surface.

8. The apparatus of claim 1, wherein the soft body file further comprises a UV mapping origin based on the grid-based topology, a UV mapping resolution of a scale of each cell based on the grid-based topology and at least one UV offset comprising an element in the array of vertices and an element UV coordinate.

9. The apparatus of claim 8, wherein the element is an identification of a vertex.

10. The apparatus of claim 8, wherein the element UV coordinate is a two-dimensional vector.

11. The apparatus of claim 8, wherein the element UV coordinate is a position where the element is added to the two-dimensional point of a corresponding grid point in two-dimensional space.

12. The apparatus of claim 1, wherein the soft body file further comprises at least one attachment pair, the at least one attachment pair defining two vertices of the at least one array of vertices that are not adjacent to each other on the two-dimensional plane but are attached to each other on the three-dimensional object.

13. The apparatus of claim 1, wherein the soft body file further comprises an at least one relationship between an at least one dependent object and the at least one soft body surface.

14. The apparatus of claim 13, wherein the at least one relationship between the at least one dependent object and the at least one soft body surface comprises a position on the at least one soft body surface based on three or more vertices of the array of vertices.

15. The apparatus of claim 1, wherein the soft body file further comprises a material specification data representing physical properties of a soft body material to be stored.

16. The apparatus of claim 1, wherein the soft body file further comprises a flat pattern data, the flat pattern data comprising:
an at least one boundary curve having two subsets, wherein the at least one boundary curve comprises an array of elements of the at least one array of vertices of the least one soft body surface; and
an at least one boundary segment pair of the two subsets of the at least one boundary curve, wherein the two subsets of the at least one boundary curve are to be attached in three-dimensional space.

17. A computer-implemented method for simulating a three-dimensional object to be projected on a two-dimensional plane within a computer, the computer having a computer processor, a volatile memory, a non-volatile memory, the computer processor connected to the volatile memory and the non-volatile memory, the computer processor executing computer-executable instructions for generating a soft body file for storing information for simulating the three-dimensional object to be projected on the two-dimensional plane, the three-dimensional object having an at least one soft body surface and a grid-based topology, the method comprising: generating a soft body file, the soft body file comprising an at least one array of vertices of the at least one soft body surface; a grid dimension of the grid-based topology; and an grid points occupancy array of the grid-based topology for the array of vertices of the at least one soft body surface.

18. The method of claim 17, wherein the soft body file further comprises a global simulation data.

19. The method of claim 17, wherein the soft body file further comprises spring types defining a vector on the grid-based topology and a spring definition.

20. The method of claim 19, wherein the spring definition comprises a distance constraint between two vertices of the at least one array of vertices of the at least one soft body surface.

21. The method of claim 17, wherein the soft body file further comprises a UV mapping origin based on the grid-based topology, a UV mapping resolution of a scale of each cell based on the grid-based topology and at least one UV offset comprising an element in the array of vertices, and an element UV coordinate.

22. The method of claim 21, wherein the element is an identification of a vertex.

23. The method of claim 21, wherein the element UV coordinate is a two-dimensional vector.

24. The method of claim 23, wherein the element UV coordinate is a position when the element is added to a two-dimensional position of the vertex's corresponding grid point in two-dimensional space.

25. The method of claim 17, wherein the soft body file further comprises at least one attachment pair identifying two vertices of the at least one array of vertices of the at least one soft body surface that are not adjacent to each other on a two-dimensional plane but are attached to each other on the three-dimensional object.

26. The method of claim 17, wherein the soft body file further comprises at least one relationship between an at least one dependent object and the at least one soft body surface.

27. The method of claim 26, wherein the relationship between the at least one dependent object and the at least one soft body surface comprises a position on the at least one soft body surface based on three or more vertices of the at least one array of vertices of the at least one soft body surface.

28. The method of claim 17, wherein the soft body file further comprises a material specification data representing physical properties of a soft body material to be stored.

29. The method of claim 17, wherein the soft body file further comprises a flat pattern data, the flat pattern data comprising at least one boundary segment pair of two subsets of at least one boundary curve, wherein the at least one boundary curve comprises an array of indices of vertices of the at least one array of vertices of the at least one soft body surface, and wherein the two subsets of the at least one boundary curve to be attached in three-dimensional space.

30. The method of claim 17, wherein the grid dimension of the grid-based topology comprises two parameters selected from the group consisting of:
a total number of grid points;
a total number of rows; and
a total number of columns.

31. The method of claim 17, wherein the array of grid point occupancy comprises an array of numbers alternating between a number of consecutive grid points that are occupied and a number of consecutive grid points that are unoccupied when all the grid points are scanned column by column or row by row.

32. A computer-readable medium having computer-executable instructions for generating a soft body file for storing information for simulating a three-dimensional object, the three-dimensional object having an at least one soft body surface and a grid-based topology, the computer-executable instructions comprising generating a soft body file comprising an at least one array of vertices of the at least one soft body surface; a grid dimension of the grid-based topology; and an array of grid point occupancy of the grid-based topology for the at least one array of vertices of the at least one soft body surface.
